(19) United States
(12) Patent Application Publication
(10) Pub. No.: US 2005/0171940 A1
(43) Pub. Date: Aug. 4, 2005

(54) Dynamic visualization of search results on a user interface

(76) Inventors: Brian J. Fogg, Healdsburg, CA (US); Jonathan L. Mann, San Francisco, CA (US)

Correspondence Address: Andre M. Gibbs;Blakely, Sokoloff, Taylor & Zafman LLP, 7th Floor, 12400 Wilshire Boulevard, Los Angeles, CA, 90025, US

(21) Appl. No.: 10/773,037

(22) Filed: Feb. 4, 2004

(51) Int. Cl. G06F 17/30

(52) U.S. Cl. 707/3

(57) ABSTRACT

The dynamic visualization of search results on a user interface is described. According to one aspect of the invention, a user interface includes a parametric control region and a display region. The parametric control region enables a user to set attributes of information of interest to a party. The display region enables a user to dynamically visualize the likelihood of specific information being of interest to the party.

### CROSS-REFERENCE TO RELATED APPLICATIONS

This application is related to copending patent application Ser. No. 10/659,580, entitled “Relationship User Interface,” filed Sep. 9, 2003; and patent application Ser. No. 10/740,361, entitled “Visualization of a Significance of a Set of Individual Elements About A Point On a User Interface,” filed Dec. 17, 2003.

### COPYRIGHT NOTICE/PERMISSION

A portion of the disclosure of this patent document contains material, which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 2003, B. J. Fogg, All Rights Reserved.

### TECHNICAL FIELD

Embodiments of the invention relate to the field of network computing and more specifically, to the dynamic visualization of search results on a user interface.

### BACKGROUND

In general, searching for information on a network consists of a user providing specific textual search criteria descriptive of the information sought to a search engine that in return provides a search result listing the information matching the search criteria. The search results typically are displayed to the user in an ordered list.

However, a user may have difficulty providing the appropriate textual description for the search criteria. If the textual search criteria are too narrow, the search result might not include the information of interest in the search result. If the textual search criteria are too broad, the user might receive a large number of search results that may include irrelevant information, and may or may not contain the information of interest to the user.

Conventional search tools might also allow the user to select specific search criteria to narrow the search result. For example, a user may visit a commercial web site that allows a user to search for gift items by category (e.g., apparel, toys, games, automobiles, computers, electronics, books, DVD, software, etc.), whereby the user is able to view an image of every item for sale that matches the selected category. However, the search results may continue to be too broad and require the user to partake in a time-consuming process of selecting each item in the search result, and perhaps scrolling down the search results page or clicking through multiple search result pages, to determine its true relevance to the user or edit the text of the search criteria to perform an additional search that might better meet the user's unique preferences.

### BRIEF SUMMARY OF THE INVENTION

The dynamic visualization of search results on a user interface is described. According to one aspect of the invention, a user interface includes a parametric control region and a display region. The parametric control region enables a user to set and manipulate attributes of information of interest to a party. The display region enables a user to dynamically visualize the likelihood of specific information being of interest to the party.

### BRIEF DESCRIPTION OF THE DRAWINGS

FIG. 1 illustrates one embodiment of a user interface.

FIG. 1A illustrates one embodiment of a gift icon having a label area.

FIG. 2 illustrates one embodiment of the user interface based on modified slider control settings.

FIG. 3 illustrates one embodiment of the user interface based on modified slider control settings.

FIG. 4 illustrates one embodiment of a network environment for performing network searching using the user interface.

FIG. 5 illustrates one embodiment of a process flow for the dynamic visualization of search results using the user interface.

FIG. 6 illustrates one embodiment of a computer system suitable for performing the features of a client device and a server device.

FIG. 7 illustrates embodiments of a slider control.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

The dynamic visualization of search results in a user interface is described. According to one aspect of the invention, individual search results are dynamically positioned on a user interface based on the significance or relevance of the search result to a set of search criteria. The following describes the set of search criteria as attributes of products and services one would consider when searching for a gift for another (e.g., significant other, friend, co-worker, boss, relation, etc.). Upon entering the desired search criteria, the related icons of one or more gift items are displayed on a user interface. The positions of the gift item icons on the user interface automatically re-position themselves based on modification of the search criteria, as will be described. However, it is understood that the invention is not limited to the search for gift items. Rather, one of ordinary skill in the art will recognize that in alternative embodiments, a variety of information may be sought and displayed. For example, the user interface may be used to identify a potential baby sitter (e.g., based on age, experience, cost, etc.), a potential mate (e.g., based on age, height, weight, education level, proximity, etc.), an electronic mail message (e.g., based on file size, age of file, file type (text, audio, video, etc.), date, etc.), among other examples.

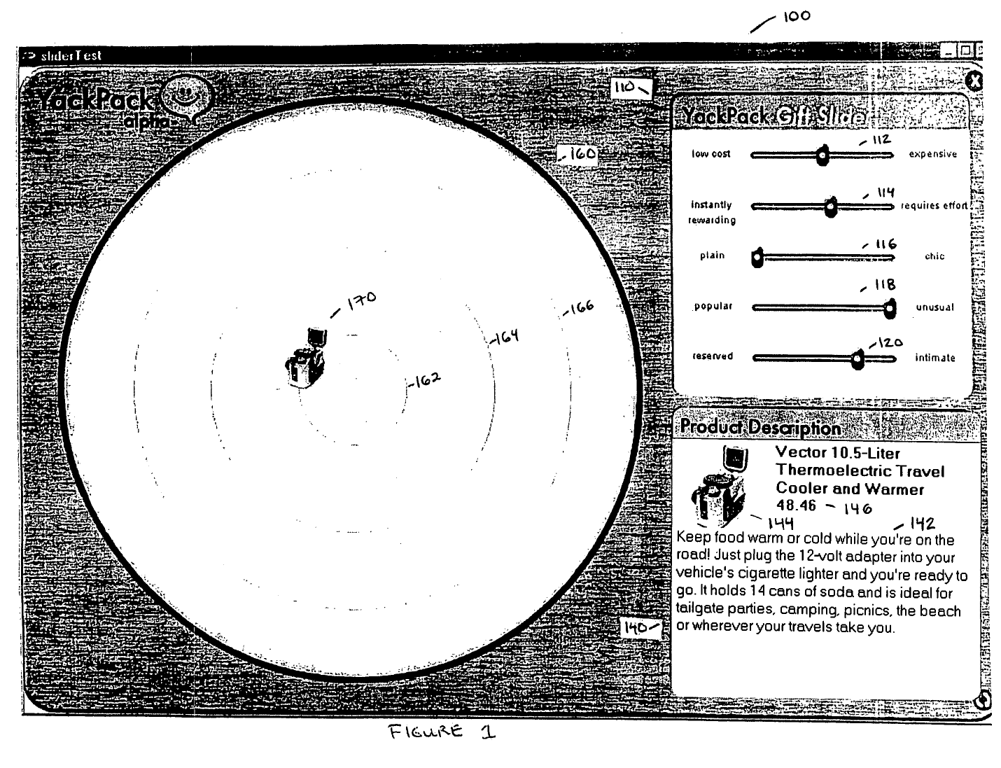

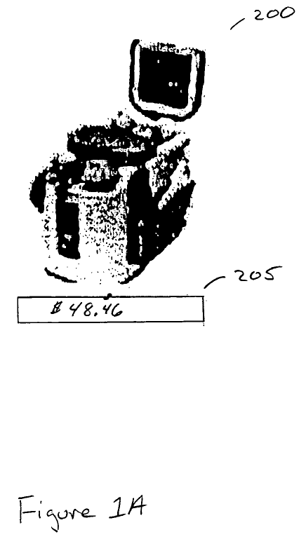

FIG. 1 illustrates one embodiment of a user interface 100. The user interface 100 includes a slider control region 110, an item description region 140, and an item display region 160. In this embodiment of the invention, the user interface 100 enables a user to search for a gift item. The gift item may include a good (e.g., a watch, a tie, etc.) or a service (e.g., hotel, air, or vehicle accommodations, etc.).

The slider control region 110 includes parametric slider controls to provide a set of search criteria for one or more gift items. For example, the slider control region 110 includes a low cost-expensive slider 112, an instantly rewarding-requires effort slider 114, a plain-chic slider 116, a popular-unusual slider 118, and a reserved-intimate slider 120. The invention is not limited to these slider dimensions shown, rather the slider control region 110 may include fewer, more, or different sliders based on the item sought, the user, the recipient, etc.

The low cost-expensive slider 112 enables a user to indicate where in a range between a low cost gift item and an expensive gift item the user desires to search. The instantly rewarding-requires effort slider 114 enables a user to indicate a preference of a gift in a range between an instantly rewarding gift and a gift that requires effort. The plain-chic slider 116 enables a user to indicate a preference of a gift in a range between a plain gift and a chic gift. The popular-unusual slider 118 enables a user to indicate a preference of a gift in a range of a popular gift or an unusual gift. The reserved-intimate slider 120 enables a user to indicate a preference of a gift in a range between a reserved gift and an intimate gift. It is apparent that the invention is not limited to the use of slider mechanisms and in alternative embodiments, other mechanisms may be used to indicate the preferences of the user, such as dials, input boxes, pull down list boxes, keyword text box, and other indicators well known to those of ordinary skill in the art. Text entry boxes might also be used to capture alphanumeric text such as price, brand-name, and size among other examples. For example, the text entry box might query the user “how would you describe the type of gift you'd like to buy.” The user may enter in the text entry box, “modern, fun, colorful,” as additional search criteria.

The item display region 160 automatically displays gift item icons that meet the search criteria, as indicated by sliders 112, 114, 116, 118, and 120 in the slider control region 110, in a radial fashion substantially about a focal point (e.g., the center) of the item display region 160. For example, given the settings of the sliders 112-120 in the slider control region 110, the item display region 160 illustrates a search result having gift item icon 170. The item description region 140 displays a brief description of a selected item in the item display region 160. For example, upon selecting the gift item icon 170, the item description region 140 displays a brief description of the gift item 142, an enlarged view of the selected gift item 144, and a price of the item selected 146. The gift item icon 170 may be selected for display in the item description region 140 upon moving a cursor over the gift item icon 170, single clicking the gift item 170, etc.

Again, referring to item display region 160, the gift item icons are positioned on the item display region 160 based on the likelihood of the gifts being relevant to the user and/or the gift recipient. In one embodiment, the closer a gift item icon is positioned relative to the center of the item display region 160, the more likely the gift is to meeting the desires of the user and/or gift recipient based on the set of search criteria visually displayed in the slider control region 110.

To aid in the visualization of the positions of the gift item icons, the item display region 160 includes rings 162, 164, and 166. In one embodiment, a gift item icon positioned inside ring 162 indicates the associated gift item is much more likely to match the preference of the user in selecting an appropriate gift, and the gift icon is less likely to match the preference of the user when positioned outside ring 166.

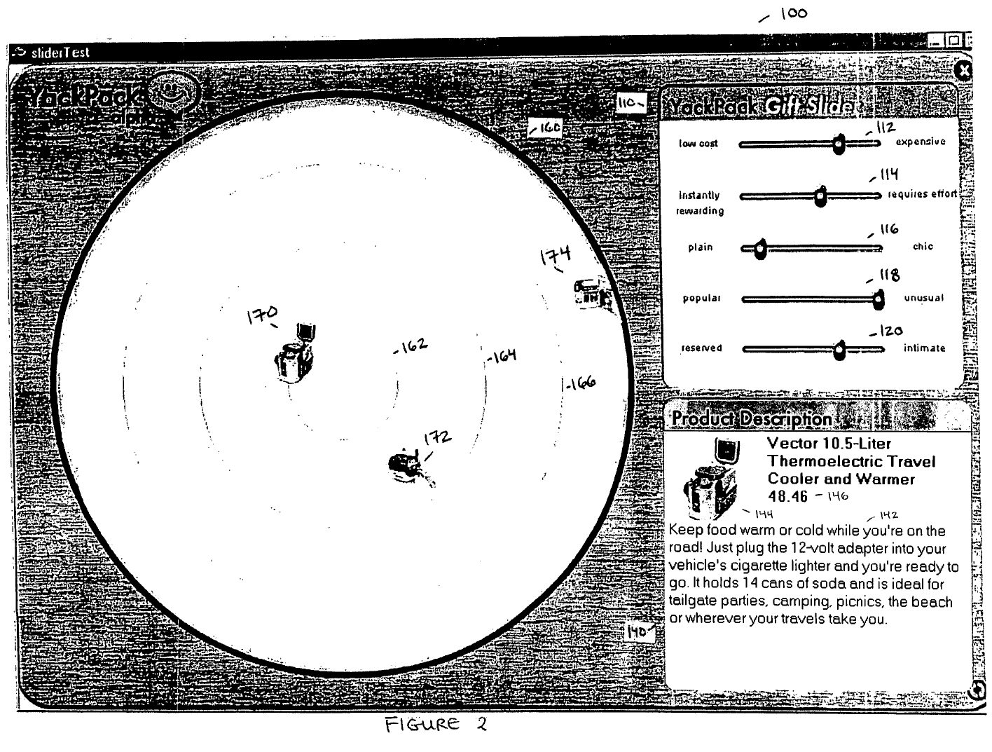

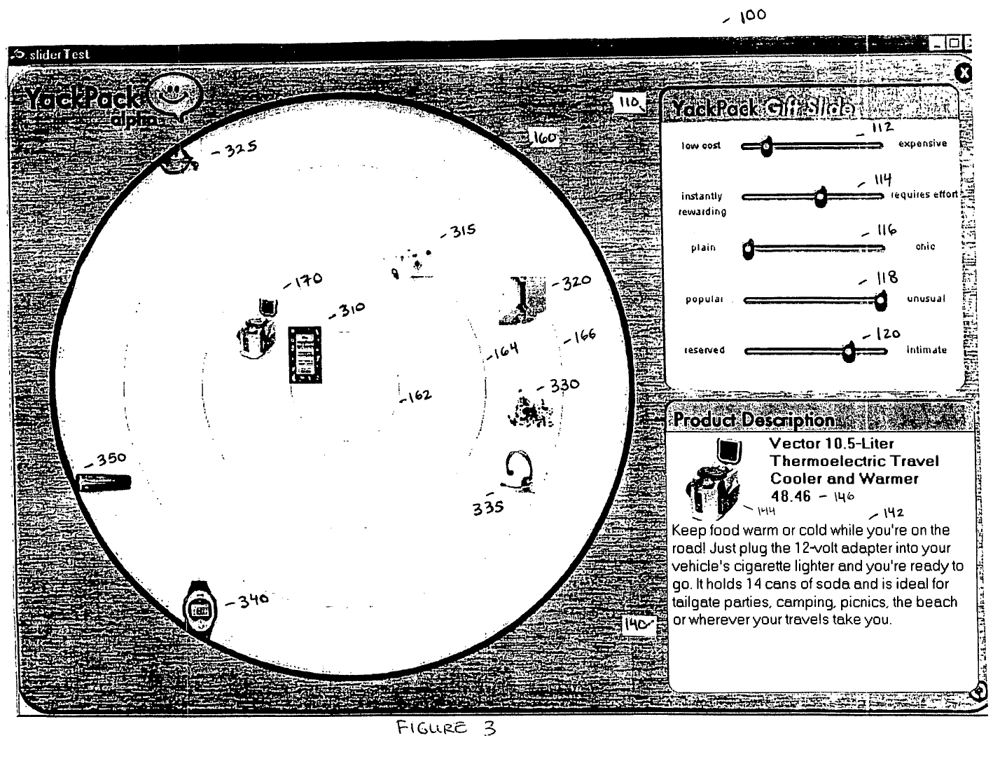

The gift item icons will dynamically move closer to or farther from the focal point of the item display region 160, automatically, as the user manipulates any of the slider controls in the slider control region 110. In a simplified example, given the slider control settings of the slider control region 110 as shown in FIG. 1, the gift item icon 170 is positioned on the item display region 160 as shown in FIG. 1. If the user manipulates the low cost-expensive slider 112 to the setting as shown in FIG. 2, the gift item icon 170, gift item icon 172, and gift item icon 174 are shown to be dynamically re-positioned as shown in the item display region 160 of FIG. 2. The gift icon might be shown to snap into the new position or shown dynamically moving across the item description region 160 into the new position with the movement of the low cost-expensive slider 112. If the user again manipulates the low cost-expensive slider 112 to the settings shown in FIG. 3, the gift item icons 170, 310, 315, 320, 325, 330, 335, 340, and 350 are shown to be dynamically re-positioned, as shown in the item display region 160 of FIG. 3. In this way, potential gift item icons automatically move in and out of the item display region 160 based on the settings of the slider controls in the slider control region 110. Furthermore, the user will dynamically visualize the search results (e.g., the gift items that best meet the preferences of the user and/or gift recipient).

The user interface 100 may also enable a user to be presented with gift item icons that are substantially similar to or not substantially similar to a specific gift item. For example, the user may select a gift icon on the item display region 160 that is not what the user prefers as a gift, such as perfume. The user may indicate (via a right mouse click menu item, menu command, etc) that this gift item or substantially similar gift items should or should not be displayed in the item display region 160. In one embodiment, the menu might include a set of discrete descriptions for the gift item (such as fragrance, breakable, Perry Ellis, toiletries, etc.). The discrete description allows the user to specify the specific one or more attributes associated with the gift item that the user prefers or does not prefer. For example, in the case of not preferring a similar item, if the user selects fragrance from the list of gift attributes, no other fragrance gift items will appear in the item display region 160 during that session. Alternatively, in the case of preferring similar items, if the user selects fragrance from the list of gift attributes, other fragrance gift items will appear in the item display region 160 during that session.

It is also understood that the user may manually drag a gift icon toward the focal point to indicate the item is of interest to the user. As the user drags the gift icon, the slider controls adjust accordingly. In this fashion, the slider controls dynamically move to match the underlying information of the dragged gift item. At the same time, other gift items dynamically move into or out of the item display region 160 that are similar or not similar to, respectively, of the dragged item. For example, if the user drags a gift item to the center of the item display region 160, such as a flashlight, all other gift items that are substantially similar to the flashlight will also move toward the center of the item display region 160.

In one embodiment, the user can roll a cursor over the item, and information about that item will appear in the description region 140 or a pop-up window substantially near the related icon. Also, the user interface 100 enables the user to display specific information along with the gift icons within a label area. FIG. 1A illustrates a gift icon 200 with a label area 205. The label area 205 indicates the price of the gift represented by the gift icon 200. It is understood that the label area 205 need not be displayed at the bottom of the gift icon, but may also be appended to the top, left, and/or right of the gift icon 200. It is understood that the user may modify the information in the label area 205 that may be presented with each gift icon. For example, the user may right click on the label area 205 to activate a drop down menu. This menu may list the possible information that the user may choose to have displayed in the label area 205, such as price, availability, country of manufacture, brand, shipping item, popularity ranking, among other examples. In one embodiment, when the information in the label area 205 is changed for one gift icon, such as from price to brand, all other gift icons in the item display region 160 will also display this information in the label area 205 (e.g., automatically switching to show brand rather than price).

In one embodiment, upon identifying an appropriate gift item (e.g., double clicking on the selected gift item icon), the user is automatically prompted for user information to purchase the item. For example, the purchasing web page of the commercial entity offering the selected gift item for sale may be automatically presented to the user upon double-clicking on the desired gift item icon. Alternately, the user can purchase the item by simply clicking on the item. For example, upon selecting (e.g., double clicking, etc) a gift item icon the necessary billing information, shipping information, etc., is automatically transmitted to the commercial entity selling the selected gift item.

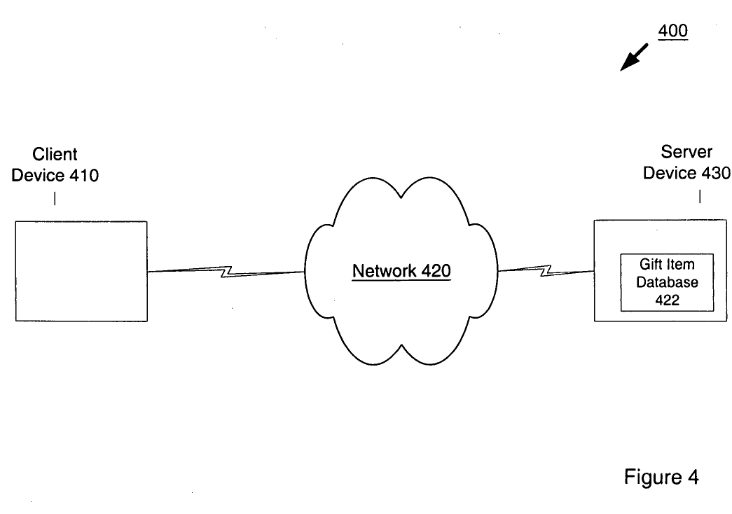

FIG. 4 illustrates one embodiment of a network environment 400 for performing network searching using the user interface 100. The network environment 400 includes a client device 410, a network 420, and a server device 430. The server device 430 may include gift item information of the available gifts to be searched. The gift item information may include a brief description of the gift item, a price of the gift item, the entity selling the gift item, an icon representing the gift item, etc. The gift information may also include a range of attributes that describe the gifts that are associated with the parametric slider controls in the slider control region 110. These attributes of each gift might be decided and inputted manually by the seller of the item or automatically from other sources. For example, the seller of the gift item may examine a gift item and give it a rating on the plain-chic scale, low cost-expensive, etc. The server device may store the gift item information in a gift item database 422.

The server device 430 may include gift item information being offered by one commercial entity or may include gift item information being offered by a plurality of commercial entities. In one embodiment, the server device 430 may receive electronic product catalog information from one or more commercial entities to populate the gift item database 422, or alternatively, the server device 430 may automatically obtain gift item information from the network web sites (not shown) of multiple commercial entities and store the gift item information on the server device 430. One of ordinary skill in the art will recognize that the user may choose to search from one or more of the commercial entities. For example, the user may only choose to search for a gift from the items of a specific commercial entity, such as Wal-Mart, Sharper Image, or Tiffany's, etc.; or alternatively search from a combination of entities such as Wal-Mart, Sharper Image, and Tiffany's. Furthermore, the user may also limit the search further to specific departments of one or more commercial entities. In this way, the item display region 160 may have more or a fewer number of gift item icons to display.

A user may use the user interface 100 on the client device 410 to access the gift item database 422 on the server device 430 via the network 420. In one embodiment, the network 420 may be the Internet, a local area network, a virtual private network, etc. The client device 410 may connect to the network 420 directly or indirectly, such as via an Internet Service Provider (not shown).

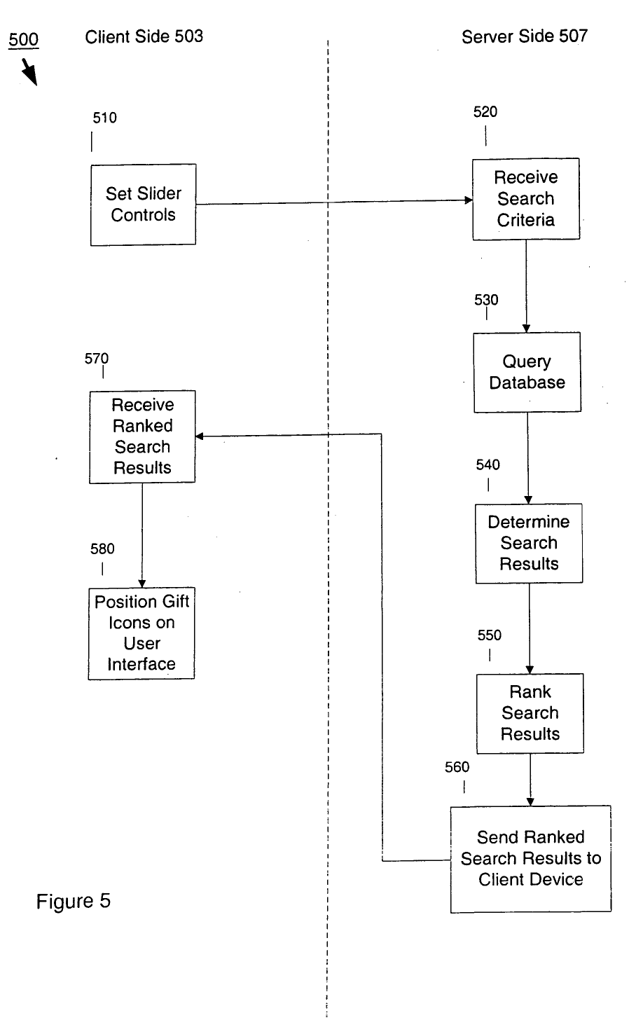

FIG. 5 illustrates one embodiment of a process flow 500 for the dynamic visualization of search results using the user interface 100. FIG. 5 is partitioned into a client side 503 and a server side 507. The client side 503 illustrates the process flow of the client device 410 and the server side 507 illustrates the process flow of the server device 430.

At block 510, the user selects the setting of the slider controls in the gift slider control region 110 describing attributes of a desired gift. The desired search criteria are encapsulated in a search criteria request to be sent to the server device 430. The encapsulated search criteria request may include the relative settings of each slider control in the slider control region 110.

At block 520, the server device 430 receives the search criteria request via the network 420 from the client device 410.

At block 530, the server device 430 queries the gift item database 422 for the gift items that substantially match the search criteria.

At block 540, the server device 430 determines a search result of gift items that substantially match the search criteria.

At block 550, the server device 430 ranks the search results based on the likelihood of the user and/or recipients of the gift desiring to select the gift item as a gift. Multiple algorithms may be used to determine whether the user and/or gift recipient is likely to desire the selected gift item based on past purchasing habits of the user, the purchasing habits of the intended recipient, the purchasing habits of the general public, items that fit the political bias of the user and/or gift recipient (e.g., eco-friendly gift items, etc.), items that complement what the recipient already owns, etc.

At block 560, the server device 430 sends the ranked search result(s) to the client device 410 via the network 420.

At block 570, the client device 410 receives the ranked search result(s) via the network 420 from the server device 430. It is understood that the client device might use additional algorithms to rank and weigh the received search results, which may be used to determine the likelihood of finding a gift of interest.

At block 580, the client device 410 positions the gift item icons of each gift item in the search result radially about the user interface 100 based on the ranking of the search results. In this fashion, the gift icons that are more likely to be associated with the given criteria are positioned closer to the focal point. In one embodiment, the user interface 100 enables the user to specify the number of gift icons to be displayed in the item display region 160. The user interface 100 might also position the gift icons to automatically avoid overlapping to make the visual display more appealing to the user.

It should be understood that portions of the gift item information may be stored in the gift item database 422 on the server device 430 or on the client device 410. In one embodiment, upon submitting subsequent search criteria, the client device 410 will only receive the ranked search results of those gift items that were not previously received to render the gift item icons on the item display region 160. In this way, the network 420 carries less network traffic between the client device 410 and the server device 430 and therefore, may render the item display region 160 with the positions of each gift item icon more quickly.

In an alternative embodiment, all the product catalog information, such as from one or more commercial entity, may be downloaded to the client device 410. The user interface 100 may then be used to dynamically filter the display of the gift items automatically as the user manipulates the slider controls. In this fashion, after the initial loading of the gift item catalog, the item display region 160 may more quickly render the display of the gift item icons as they dynamically transition into various positions, as the user manipulates the slider controls.

It will be appreciated that more or fewer processes may be incorporated into the method illustrated in FIG. 5 without departing from the scope of the invention and that no particular order is implied by the arrangement of blocks shown and described herein. It further will be appreciated that the methods described in conjunction with FIG. 5 may be embodied in machine-executable instructions, (e.g. software). The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The methods may be provided as a computer program product that may include a machine-readable medium having stored thereon instructions that may be used to program a computer (or other electronic devices) to perform the methods. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to include, but not be limited to, solid-state memories, optical and magnetic disks, and carrier wave signals. Furthermore, it is common in the art to speak of software, in one form or another (e.g., program, procedure, process, application, module, logic, etc.), as taking an action or causing a result. Such expressions are merely a shorthand way of saying that execution of the software by a computer causes the processor of the computer to perform an action or produce a result.

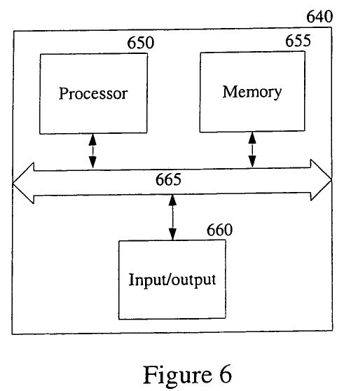

FIG. 6 illustrates one embodiment of a computer system suitable for performing the features of the client device 410 and the server device 430. The computer system 640 includes a processor 650, a memory 655, and an input/output capability 660, all coupled to a system bus 665. Such a configuration encompasses personal computer systems, network computers, television based systems, such as Web TVs or set-top boxes, handheld devices, such as mobile phones and personal digital assistants, and other similar devices.

The processor 650 represents a central processing unit of any type of architecture such as a CISC, RISC, VLIW, DSP, or hybrid architecture. In addition, the processor 650 could be implemented on one or more chips. The memory 655 is configured to store instructions which, when executed by the processor 650, perform the methods described herein. The memory 655 may also store user information, product/services information, etc.

Input/output 660 may include components to facilitate user interaction with the computer system 640 such as a keyboard, a mouse, a display monitor, a microphone, a speaker, a display, a network card (e.g., Ethernet, Inferred, cable modem, Fax/Modem, etc.), etc. For example, input/output 660 provides for the display of the user interface 100 or portions or representations thereof. Input/output 660 also encompasses various types of machine-readable media, including any type of storage device that is accessible by the processor 650. For example, a machine-readable medium may include read only memory (“ROM”); random access memory (“RAM”); magnetic disk storage media; optical storage media; flash memory devices; electrical, optical, acoustical, or other forms of propagated signals (e.g., carrier waves, infrared signals, digital signals, etc.), etc. Thus, a machine-readable medium includes any mechanism that provides (i.e., stores and/or transmits) information in a form readable by a machine (e.g., a computer). One of skill in the art will immediately recognize that the term “machine-readable medium/media” further encompasses a carrier wave that encodes a data signal.

In addition, the bus 665 may represent one or more busses (e.g., PCI, ISA, X-Bus, EISA, VESA, etc.) and bridges (also termed as bus controllers).

The description of FIG. 6 is intended to provide an overview of computer hardware and other operating components suitable for implementing the invention, but is not intended to limit the applicable environments. It will be appreciated that the computer system 640 is one example of many possible computer systems that have different architectures. A typical computer system will usually include at least a processor, a memory, and a bus coupling the memory to the processor. One of skill in the art will immediately appreciate that the invention can be practiced with other computer system configurations, including mobile portable devices, home entertainment system, home networking systems, multiprocessor systems, minicomputers, mainframe computers, and the like. The invention can also be practiced in distributed computing environments where tasks are performed by remote processing devices that are linked through a communications network.

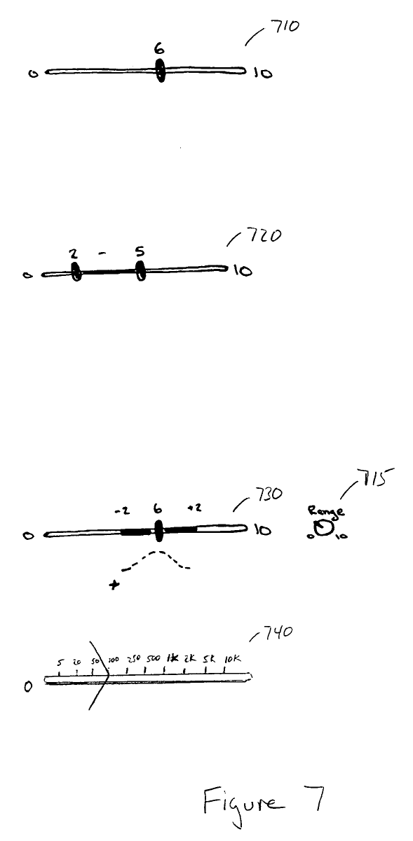

It should be understood that the slider control may also include additional embodiments as shown in FIG. 7, such as a single point slider control 710, a range slider control 720, a variable range slider control 730, and a one-sided slider 740. The single point slider control 710 may indicate an explicit setting value. For example, if the slider control 710 is a monetary value for a gift and is set to six dollars, then the search will be specifically limited to gift items that cost exactly six dollars.

The range slider control 720 enables a user to indicate a lower and upper range limit. For example, if the range slider control 720 is a monetary value for a gift and the low limit is set to two dollars and the upper limit is set to five dollars, then the search will be specifically limited to gift items that cost at and between two and five dollars.

The variable range slider control 730 enables a user to indicate a specific point value, however, the user interface will automatically select items at a standard deviation from the selected point. For example, the user interface may be configured by the user to set the standard deviation of the variable range slider to be plus and minus two. Therefore, if the variable range slider control 730 is a monetary value for a gift and is set to six dollars, then the user interface will automatically adjust the range of the search for a gift item that costs at and between four and eight dollars. In this example, the user interface might display items closer to the focal point that more closely favors items in the center of the range (e.g., those costing about six dollars).

The one sided slider 740 enables a user to indicate a lower or upper range to be searched. For example, the one sided slider 740, as shown in FIG. 7 indicates the desire of the user to only have displayed gift items that are less than 100 dollars.

It is understood that the user may dynamically change the slider type of a particular slider by right-clicking on that slider and selecting the slider type from a drop-down menu among other methods. It is also understood that each slider control in the slider control region 110 may vary in importance (e.g., weight). For example, the low cost-expensive slider 112 might be of more importance to the user than the popular-unusual slider 118.

In one embodiment, the user may set the weighed importance of each slider control using an importance dial 715. The importance dial 715 indicates the importance of a related slider control. For example, when the importance dial 715 is set to the highest setting (e.g., ten), the user interface will weigh the cost of the item as very important when ranking and positioning the related gift icon on the item display region 160. It is apparent that the importance dial 715 may be represented in numerous numeric or descriptive embodiments, such as a pull down list, a slider among other example, and the invention is not limited to use of a dial settings indicator.

In one embodiment, the user may set the importance of each slider by repositioning the ranking order of each slider control in the slider control region 110. For example, given the order of the slider controls in the slider control region 110, the cost-expensive slider 112 is of more importance and the reserved-intimate slider 120 is of less importance. The user may “drag and drop” each slider control into the desired importance ranking order using a drag and drop handle or up/down control button. In one embodiment, the size of the slider control may vary based on the indicated importance of the slider control. For example, when the importance dial 715 is set to the highest setting, the related slider control will appear larger than a slider control that is set to a lower setting.

In one embodiment, the weighed importance of each slider control is based on the habits of the user, the habits of the recipient of the gift, the habits of the general public, the knowledge base of a specific commercial entity, etc. For example, the user interface 100 may enable the user to specify the recipient of the gift and/or the specific commercial entity from which to search for the gift. In this way, the user interface 100 may obtain known attributes of the recipient of the gift and/or obtain known attributes of previous purchases on the commercial entity to pre-set the weighted importance of one or more of the slider controls in the slider control region 110.

In one embodiment, the user interface enables the user to provide information about the recipient of the gift, which is also used to rank and position the gift icons in the item display region 160. For example, the user may manually indicate the gift recipient is a fourteen-year-old girl, whereas the user interface will facilitate the search for gift items that include attributes substantially suitable for a fourteen-year-old girl and/or filter out the display of gift items that are not appropriate for a fourteen-year-old girl.

Thus, a dynamic visualization of search results on a user interface has been described. The use of parametric control sliders enable a user to specify search criteria and to dynamically display the search results in a radial fashion about a focal point on the item display region 160 thereby enabling a user to visually determine the likelihood of selecting the item. As stated, the invention is not limited to searching for a gift item, but may provide an interface by which an end-user may search for and receive search results for numerous items and information of interest having a varying set of search criteria dimensions, such as a potential mate, activity partner, business partner, business contacts, among other examples.

For example, the user interface 100 might be part of a dating service, which is configured and used by a user to search for a potential mate. In which case, icons (e.g., picture of persons) representing potential mates dynamically position relative to the focal point in the display region 160 upon manipulation of appropriate slider controls in the slider control region 110. The slider controls may represent attributes (such as age, height, proximity, education level, etc) to enable the user to search for a compatible potential mate. The user might configure the label area of the icon to include information such as name, age, education level, income level, horoscope, weight, height, profession, and proximity, among other examples. Also, the user interface 100 enables the user to search for or filter-out persons with specific attributes; or the user might drag the image of a specific person toward the focal point and all the other potential dates that are similar to that person will also move closer to or farther from the focal point. Also, additional information might be presented about a specific person upon selecting the person or the user might automatically contact the person (e.g., via email, instant messaging, voice communications, etc) to setup a date.

It is understood that the user interface 100 is not limited to positioning icons about a focal point in the center of the item display region 160. Rather, the focal point might be positioned anywhere (e.g., the top right corner) on the item display region 160. The focal point may or more not be visible on the item display region 160. Furthermore, the user interface 100 is not limited to positioning icons about a focal point to indicate significance. Rather, in an alternative embodiment, other visual characteristics might be used, other than the traditional search result list, to visualize the importance or significances of the results of the slider control manipulations. For example, upon manipulating the slider controls, the gift icons might increase in size, decrease in size, or disappear in the item display region 160.

In another example, the item display region 160 might position the icons relative to an x and y axis to indicate a significance of the icon. For example, the x-axis might represent the main criterion and the y-axis is a compilation of all other criteria. As a concrete example in the case of a dating service, the x-axis could represent educational level (the most important criterion for the user) and the y-axis would represent a combination of all other attributes of interest combined according to a specified algorithm being relevant to the user. Hence, the further to the right relative to the x-axis the icon is positioned indicates the higher the education level of the potential mate; and the further up relative to the y-axis the icon is positioned indicates the more likely the combination of all the other attributes are relevant to the user, and vice-versa. In the case of gift selection, the x-axis might represent price (e.g., the most important attribute), while the y-axis would represent a combination of all other attributes of interest combined according to a specified algorithm. Hence, the further to the right relative to the x-axis the icon is positioned indicates the higher the price of the item; and the further up relative to the y-axis the icon is positioned indicates the more likely the combination of all the other attributes are relevant to the user, and vice-versa.

Accordingly, while the invention has been described in terms of several embodiments, those skilled in the art will recognize that the invention is not limited to the embodiments described. The method and apparatus of the invention can be practiced with modification and alteration within the scope of the appended claims. The description is thus to be regarded as illustrative instead of limiting on the invention.

1. A device comprising:
a user interface comprising:
a control region, the control region to include one or more controls to set an attribute of information; and
a display region, the display region including an icon and a focal point, wherein the icon to represent the information and the icon is displayed relative to the focal point based on a ranking of the information.

2. The device of claim 1, wherein the information includes at least one of a good and a service.

3. The device of claim 1, wherein the information includes personal information of a potential mate.

4. The device of claim 1, wherein the information include information of an organization.

5. The device of claim 1, wherein the control region enables a user to set search criteria for a search engine.

6. The device of claim 1, wherein the control region includes a slider control.

7. The device of claim 1, wherein the control region includes a keyword text box.

8. The device of claim 1, wherein the icon is positioned in the display region close to the focal point when the ranking indicates the related information is likely to be of importance to a party.

9. The device of claim 8, wherein the party is a user of the device.

10. The device of claim 8, wherein the party is the recipient of the information.

11. The device of claim 1, wherein the icon dynamically re-positions in the display region upon modification of a control in the control region.

12. The device of claim 1, further comprising:
a description region to provide a description of the information.

13. The device of claim 1, wherein the ranking includes weighing the one or more controls to position the icon relative to the focal point in the display region.

14. The device of claim 1, wherein the icon includes a label area.

15. A machine-readable medium having instructions to cause a machine to perform a method, the method comprising:
positioning one or more icons in a display region on a user interface based on settings of one or more controls in a control region of the user interface, wherein the one or more icons represent a search result; and
re-positioning the one or more icons in the display region when the one or more controls are modified.

16. The machine-readable medium of claim 15 further comprising:
receiving search criteria based on the settings of the one or more controls; and
ranking the search result based on the settings of the one or more controls, wherein the re-positioning of the one or more icons in the display region is based on the ranking of the search result.

17. The machine-readable medium of claim 15, wherein the positioning of the one or more icons in the display region further includes positioning a first icon of the one or more icons closer relative to a focal point in the display region when the first icon is more likely to be of importance to a party, the first icon to represent at least one of a good or a service.

18. The machine-readable medium of claim 15, further comprising:
configuring a weight of the settings of one or more controls, wherein the weight of the settings of the one or more controls are used to rank the search result.

19. The machine-readable medium of claim 15, further comprising:
selecting a second icon of the one or more icons; and
displaying a description of the second icon in a description region.

20. The machine-readable medium of claim 15, further comprising:
automatically re-positioning the settings of the one or more controls in the display region upon receiving an indication that the user is re-positioning one of the one or more icons in the display region, wherein the one or more icons are re-positioned in the display region.

21. The machine-readable medium of claim 15, further comprising:
displaying information in a label area attached to each of the one or more icons;
receiving an indication to modify the information in the label area for each of the one or more icons; and
modifying the information in the label area for each of the one or more icons.

22. The machine-readable medium of claim 15, further comprising:
reconfiguring a slider type of one of the one or more controls based on a slider type selection made by a user.

23. A device comprising:
a user interface comprising:
a means for setting an attribute of at least one of a good and a service; and
a means for representing the at least one good and service in a display region on the user interface, wherein the means for representing the at least one of the good and the service is positioned relative to a focal point on the display region based on a ranking of the at least one good and service.

24. The device of claim 23, wherein the ranking of the at least one good and service includes weighing the means for setting an attribute.

25. The device of claim 23, further comprising:
a means for displaying a description of the at least one good and service.

26. A device comprising:
a user interface comprising:
a control region, the control region to include one or more controls to set an attribute of information;
a display region, the display region including an icon, an x-axis, and an y-axis, wherein the icon to represent the information and the icon is displayed relative to the x-axis and the y-axis based on a ranking of the information.

27. The device of claim 26, wherein the icon dynamically re-positions in the display region upon modification of a control in the control region.

28. The device of claim 26, wherein the x-axis to represent a price of an item.

29. The device of claim 26, wherein the y-axis to represent a relevance of a combination of the information.
